(19) United States
(12) Patent Application Publication
(10) Pub. No.: US 2003/0144033 A1
(43) Pub. Date: Jul. 31, 2003

(54) Multi-carrier communication method and multi-carrier communication apparatus

(76) Inventors: Atsushi Sumasu, Yokosuka-shi (JP); Katsuhiko Hiramatsu, Yokosuka-shi (JP); Kenichi Miyoshi, Yokohama-shi (JP)

Correspondence Address: STEVENS DAVIS MILLER & MOSHER, LLP, 1615 L STREET, NW, SUITE 850, WASHINGTON, DC, 20036, US

(21) Appl. No.: 10/312,725

(22) PCT Filed: May 13, 2002
(86) PCT No.: PCT/JP02/04591

(30) Foreign Application Priority Data
May 14, 2001 (JP) 2001-143490

(51) Int. Cl. H04B 1/38

(52) U.S. Cl. 455/562; 455/552

(57) ABSTRACT

SFTD coding section 10 adjusts a sequence of frequency arrangement and phases of transmit data digital symbols in a time series and thus generates at least two transmit signals. The transmit signals are transformed into parallel signals in serial/parallel transform sections 11 and 12, and subsequently transformed into OFDM signals in IDFT sections 13 and 14 and parallel/serial transform sections 15 and 16, respectively. In this way, by using the multicarrier transmission scheme, it is made possible to encode on the frequency axis signals conventionally encoded only on the time axis, and it is thus possible to decrease the processing delay while obtaining the same diversity effect as in the STTD transmit diversity scheme.

### TECHNICAL FIELD

The present invention relates to a multicarrier communication method and multicarrier communication apparatus.

### BACKGROUND ART

In general, mobile radio communication environments are greatly affected by multipath fading. In transmission at ultra broad frequency bands, the effect of frequency selective fading further increases, and becomes a factor for degrading the system performance.

As a method of preventing the degradation of performance by the fading, there is considered the use of diversity. Conventionally, the diversity primarily used is reception diversity whose processing is executed on a receiving side. Recently, transmit diversity has been used in which a transmitting side performs diversity transmission and it is thereby possible to obtain the diversity effect with simplified operation while reducing loads on mobile terminals.

One of conventional transmit diversity is STTD (Space Time coding based Transmit antenna Diversity) in which transmit signals are transmitted concurrently using a plurality of antennas and subjected to maximal-ratio combining so as to obtain diversity gain (for example, “Performance of OFDM-CDMA Systems with Transmit Diversity of Forward Link Transmission”, Incheol JEONG and Masao NAKAGAWA, Technical Report of IEICE). STTD transmit diversity is such a scheme that alters transmit signals in time sequence to encode and transmits the signals from a plurality of antennas.

FIG. 1 is a diagram to explain the transmit diversity in the conventional STTD scheme.

In this figure, from antenna 1 a signal S₀ is transmitted at time t₀ and a signal S₁ is transmitted at time t₁, while from antenna 2 a signal −S₁* is transmitted at time t₀ and a signal S₀* is transmitted at time t₁. These signals are added on a receiving side, and multiplied by transfer function h₀ or h₁, thereby obtaining a received signal r₀ at a timing of t₀ and a received signal r₁ at a timing of t₁. In other words, received signals r₀ and r₁ expressed by following equations (1) and (2) are obtained. In addition, “*” in the equations denotes complex conjugate.

t₀:r₀=h₀S₀−h₁S₁* (1)

t₁:r₁=h₀S₁+h₁S₀* (2)

Since signals S₀ and S₁ coexist in both equations (1) and (2), the signals S₀ and S₁ cannot be extracted. Therefore, adding the product of r₀ and h₀* and the product of h₁ and r₁* leads to equation (3) where a received signal S₀r is expressed using multiplications of S₀ by constants (h₀*h₀ and h₁h₁*).

$$\begin{matrix}{S}_{0} r = {h}_{0} * {r}_{0} + {h}_{1} {r}_{1} * \\ = {h}_{0} * {h}_{0} {S}_{0} - {h}_{0} * {h}_{1} {S}_{1} * + {h}_{0} * {h}_{1} {S}_{1} * + {h}_{1} {h}_{1} * {S}_{0} \\ = {h}_{0} * {h}_{0} {S}_{0} + {h}_{1} {h}_{1} * {S}_{0}\end{matrix} \qquad ( 3 )$$

Similarly, adding the product of r₀* and −h₁ and the product of h₀* and r₁ leads to equation (4) where a received signal S₁r is expressed using multiplications of S₁ by constants (h₁h₁* and h₀*h₀).

$$\begin{matrix}{S}_{1} r = - {h}_{1} {r}_{0} * + {h}_{0} * {r}_{1} \\ = - {h}_{1} {h}_{0} * {S}_{0} * + {h}_{1} {h}_{1} * {S}_{1} + {h}_{0} * {h}_{0} {S}_{1} + {h}_{0} * {h}_{1} {S}_{0} * \\ = {h}_{1} {h}_{1} * {S}_{1} + {h}_{0} * {h}_{0} {S}_{1}\end{matrix} \qquad ( 4 )$$

Transfer functions h₀ and h₁ are measured in advance on a receiving side by channel estimation and determined, thereby obtaining a result of maximal-ratio combining. The signal combined by STTD transmit diversity is equivalent to a signal of the maximal-ratio combining performed on the receiving side. In addition, while the above example illustrates the case of using two signals, S₀ and S₁, cases of using two or more signals obtain the same result.

The STTD transmit diversity is as described above.

Thus, in the conventional STTD transmit diversity, channel bits composing transmit data are altered in time sequence or in phase. However, altering the time sequence or phase results in time delay.

### DISCLOSURE OF INVENTION

It is an object of the present invention to provide a multicarrier communication method and multicarrier communication apparatus enabling decreased processing delay with the same effectiveness as in STTD transmit diversity.

The object is achieved by encoding transmit data at the frequency domain using the multicarrier transmission scheme.

### BRIEF DESCRIPTION OF DRAWINGS

FIG. 1 is a diagram to explain the transmit diversity in the conventional STTD scheme;

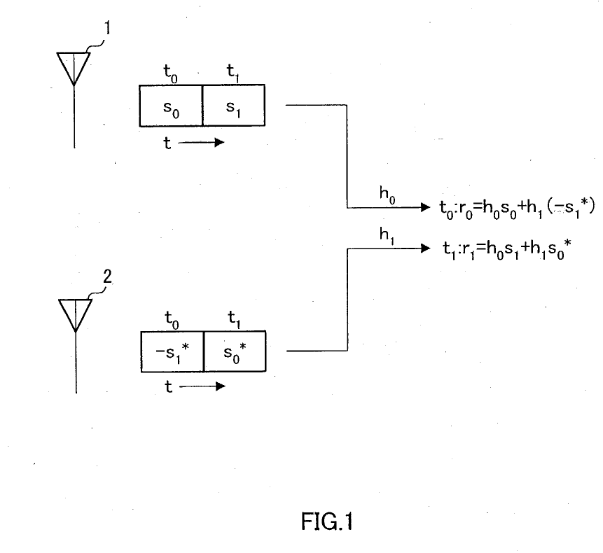

FIG. 2 is a block diagram illustrating a configuration of a multicarrier transmission apparatus according to a first embodiment of the present invention;

FIG. 3 is a diagram to explain the transmit diversity in the multicarrier transmission apparatus according to the first embodiment of the present invention; and

FIG. 4 is a block diagram illustrating a configuration of a multicarrier reception apparatus according to a second embodiment of the present invention.

### BEST MODE FOR CARRYING OUT THE INVENTION

Preferred embodiments of the present invention will be described below specifically with reference to accompanying drawings.

(First Embodiment)

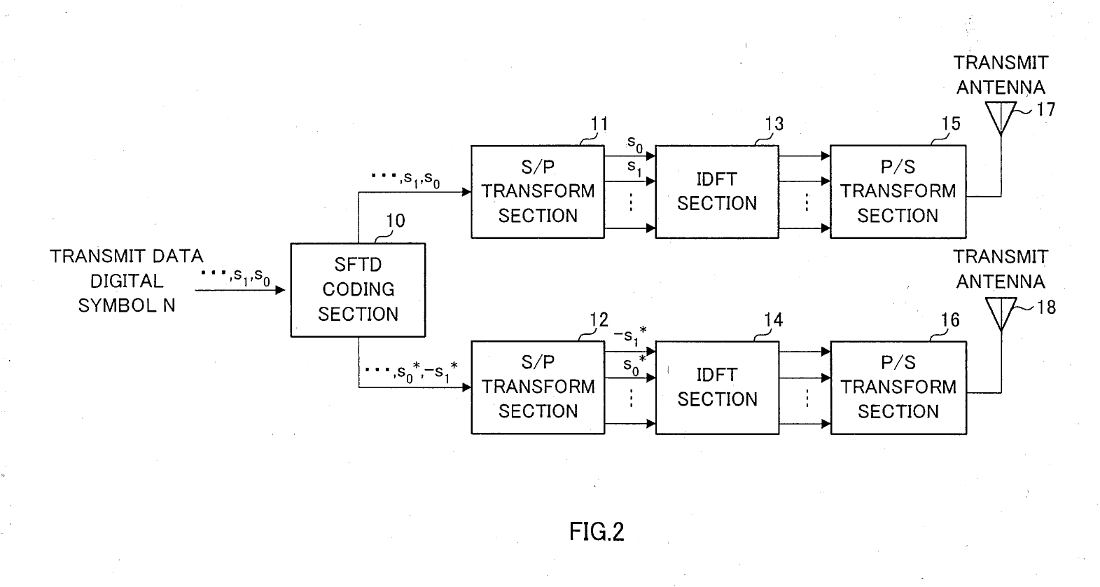

FIG. 2 is a block diagram illustrating a configuration of a multicarrier transmission apparatus according to the first embodiment of the present invention.

In this figure, the multicarrier transmission apparatus of this embodiment has SFTD (Space Frequency coding based Transmit antenna Diversity) coding section 10, serial/parallel (S/P) transform section 11, serial/parallel (S/P) transform section 12, IDFT (Inverse Discrete Fourier Transform) section 13, IDFT (Inverse Discrete Fourier Transform) section 14, parallel/serial (P/S) transform section 15, parallel/serial (P/S) transform section 16, transmit antenna 17 and transmit antenna 18.

SFTD coding section 10 adjusts (SFTD coding) the sequence of frequency arrangement and phase of transmit data digital symbols S₀, S₁, . . . input in a time series to output to sections for two antennas. At this point, the section 10 outputs transmit data digital symbols S₀, S₁, . . . that are not adjusted and transmit data digital symbols −S₁*, S_{0*}, . . . that are adjusted. The non-adjusted transmit data digital symbols S₀, S₁, . . . are subjected to parallel transform in serial/parallel transform section 11 to be input to IDFT section 13. IDFT section 13 performs frequency transform on the input parallel transmit data digital symbols S₀, S₁, . . . to output. Parallel/serial transform section 15 performs serial transform on signals from IDFT section 13 and thus outputs OFDM (Orthogonal Frequency Division Multiplexing) signals to transmit antenna 17.

Meanwhile, the adjusted transmit data digital symbols −S₁*, S₀* . . . are subjected to parallel transform in serial/parallel transform section 12 to be input to IDFT section 14. IDFT section 14 performs frequency transform on the input parallel transmit data digital symbols −S₁*, S₀*, . . . to output. Parallel/serial transform section 16 performs serial transform on signals from IDFT section 14 and thus outputs OFDM (Orthogonal Frequency Division Multiplexing) signals to transmit antenna 18.

In this way, SFTD coding section 10 adjusts the sequence of frequency arrangement and phase of transmit data digital symbols S₀, S₁, . . . input in a time series to provide to sections for two antennas. Serial/parallel transform sections 11 and 12 perform parallel transform on the provided transmit signals, IDFT sections 13 and 14 and parallel/serial transform sections 15 and 16 generate OFDM signals, and the signals are transmitted from transmit antennas 17 and 18.

In the present invention, since signals are concurrently transmitted at a plurality of frequency bands using the multicarrier scheme, it is possible to remarkably decrease the processing delay as compared to the conventional processing for interchanging the sequence of frequency arrangement and phases of transmit signal components on the time axis. Also in the SFTD transmit diversity using the multicarrier scheme, it is possible to extract received signals subjected to maximal-ratio combining as in the STTD transmit diversity.

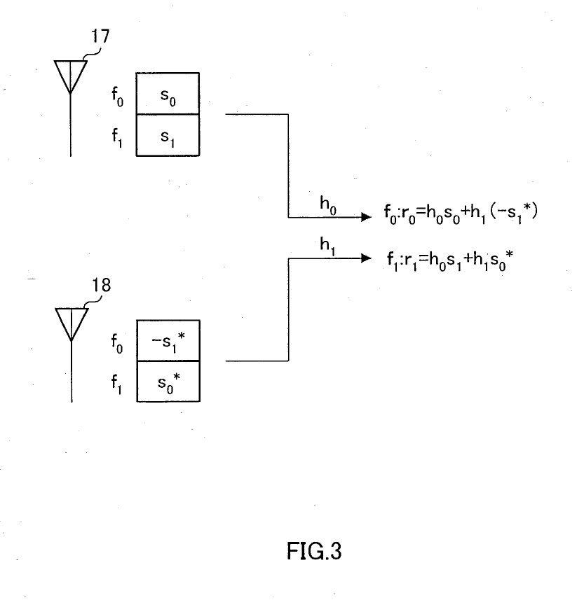

FIG. 3 is a diagram to explain the transmit diversity in the SFTD scheme in this embodiment.

As illustrated in this figure, from transmit antenna 17 a signal S₀ is transmitted at frequency F₀ and a signal S₁ is transmitted at frequency F₁, while from transmit antenna 18 a signal −S₁* is transmitted at frequency F₀ and a signal S₀* is transmitted at frequency F₁. These signals are added on a receiving side, and multiplied by transfer function H₀ or H₁, thereby obtaining a received signal R₀ at a timing of F₀ and a received signal R₁ at a timing of frequency F₁. In other words, received signals r₀ and r₁ expressed by following equations (5) and (6) are obtained. In addition, “*” in the equations denotes complex conjugate.

f₀:r₀=h₀S₀+h₁(−S₁*) (5)

f₁:r₁=h₀S₁+h₁S₀* (6)

Since signals S₀ and S₁ coexist in both equations (5) and (6), the signals S₀ and S₁ cannot be extracted. Therefore, adding the product of r₀ and h₀* and the product of h₁ and r₁* leads to equation (7) where a received signal S₀r is expressed using multiplications of S₀ by constants (h₀*h₀ and h₁h₁*).

$$\begin{matrix}{S}_{0} r = {h}_{0} * {r}_{0} + {h}_{1} {r}_{1} * \\ = {h}_{0} * {h}_{0} {S}_{0} - {h}_{0} * {h}_{1} {S}_{1} * + {h}_{0} * {h}_{1} {S}_{1} * + {h}_{1} {h}_{1} * {S}_{0} \\ = {h}_{0} * {h}_{0} {S}_{0} + {h}_{1} {h}_{1} * {S}_{0}\end{matrix} \qquad ( 7 )$$

Similarly, adding the product of r₀* and −h₁ and the product of h₀* and r₁ leads to equation (8) where a received signal S₁r is expressed using multiplications of S₁ by constants (h₁h₁* and h₀*h₀).

$$\begin{matrix}{S}_{1} r = - {h}_{1} {r}_{0} * + {h}_{0} * {r}_{1} \\ = - {h}_{1} {h}_{0} * {S}_{0} * + {h}_{1} {h}_{1} * {S}_{1} + {h}_{0} * {h}_{0} {S}_{1} + {h}_{0} * {h}_{1} {S}_{0} * \\ = {h}_{1} {h}_{1} * {S}_{1} + {h}_{0} * {h}_{0} {S}_{1}\end{matrix} \qquad ( 8 )$$

Transfer functions h₀ and h₁ are measured in advance on a receiving side by channel estimation and determined, thereby obtaining a result of maximal-ratio combining. The signal combined by SFTD transmit diversity is equivalent to a signal of the maximal-ratio combining performed on the receiving side. In addition, while the above example illustrates the case of using two signals, S₀ and S₁, cases of using two or more signals obtain the same result.

Thus, according to the multicarrier transmission apparatus of this embodiment, since signals are concurrently transmitted at a plurality of frequency bands using the multicarrier transmission scheme, it is possible to remarkably decrease the processing delay as compared to the conventional processing for interchanging the sequence of frequency arrangement and phases of transmit signal components on the time axis like in the conventional STTD transmit diversity. Accordingly, it is possible to provide a multicarrier communication apparatus and multicarrier communication method enabling decreased processing delay while obtaining the effect of STTD transmit diversity.

In addition, while in this embodiment OFDM is used as a multicarrier transmission scheme, the present invention is not limited to such a scheme, and may use other methods (for example, such a method that implements the multicarrier transmission using limited bands obtained by performing carrier frequency modulation for each subcarrier).

Further, according to this embodiment, as illustrated in FIG. 2, transmit data digital symbols S₀, S₁, . . . input time in a time series are subjected to adjustments in frequency arrangement and phase; the adjustments in frequency arrangement and phase are not limited particularly. In other words, interchanged matters maybe determined in advance between transmitting and receiving sides, or a transmitting side may add information on interchanging of the sequence of frequency arrangement and phase to pilot signals or the like, while a receiving side extracts transmit signal components based on the information.

(Second Embodiment)

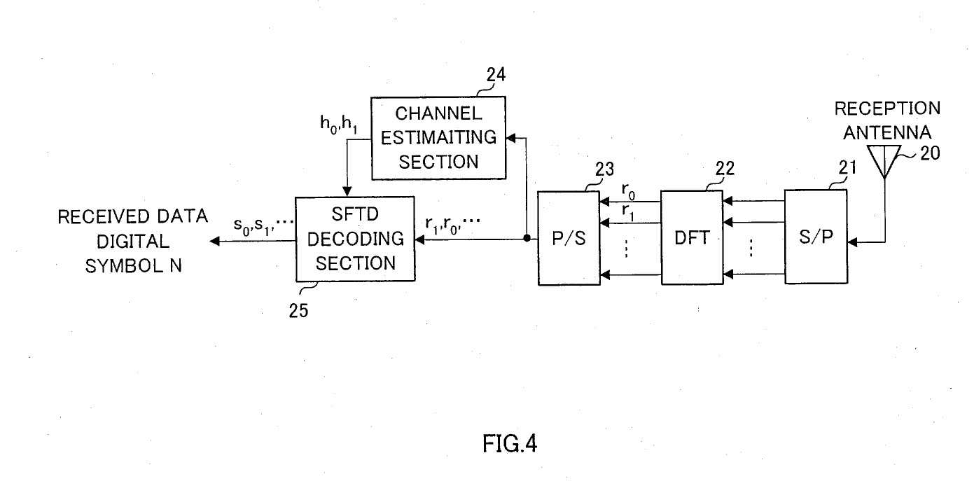

FIG. 4 is a block diagram illustrating a configuration of a multicarrier reception apparatus according to the second embodiment of the present invention.

In this figure, the multicarrier reception apparatus of this embodiment has reception antenna 20, serial/parallel (S/P) transform section 21, DFT (Discrete Fourier Transform) section 22, parallel/serial (P/S) transform section 23, channel estimating section 24 and SFTD decoding section 25.

Serial/parallel transform section 21 performs parallel transform on OFDM signals received at reception antenna 20 and thus extracts a signal of each frequency component. DFT section 22 performs OFDM demodulation on signals extracted in serial/parallel transform section 21 to obtain received signals r₀, r₁, . . . for each frequency component. Parallel/serial transform section 23 performs serial transform on received signals r₀, r₁, . . . for each frequency component obtained in DFT section 22 to output. Channel estimating section 24 estimates the channel condition using pilot signals, etc. in received signals, and outputs channel estimation values h₀ and h₁ that are results of channel estimation. SFTD decoding section 25 performs SFTD decoding using the received signals and channel estimation values h₀ and h₁, and thereby obtains original transmit digital symbols S0, S1, . . .

In this way, according to the multicarrier reception apparatus of this embodiment, it is possible to demodulate OFDM signals transmitted from the multicarrier transmission apparatus of this embodiment as described above and to obtain original transmit digital symbols S₀, S₁, . . . Accordingly, by combining the multicarrier reception apparatus with the multicarrier transmission apparatus of the first embodiment, it is possible to achieve a multicarrier communication apparatus enabling decreased processing delay while obtaining the effect of STTD transmit diversity.

In addition, while in this embodiment OFDM is used as a multicarrier transmission scheme, the present invention is not limited to such a scheme, and may use other methods (for example, such a method that implements the multicarrier transmission using limited bands obtained by performing, carrier frequency modulation for each subcarrier).

As described above, according to the present invention, it is possible to provide a multicarrier communication apparatus and multicarrier communication method enabling decreased processing delay while obtaining the effect of STTD transmit diversity.

This application is based on the Japanese Patent Application No.2001-143490 filed on May 14, 2001, entire content of which is expressly incorporated by reference herein.

The present invention is suitable for use in terrestrial digital broadcast apparatuses and fast wireless LAN.

1. A multicarrier communication method comprising:
on a transmitting side,
adjusting a sequence of frequency arrangement and phases of transmit signal components in a time series to generate transmit signals; and
transmitting the signals using at least two antennas,
on a receiving side,
receiving radio signals transmitted from the transmitting side using a single antenna; and
combining a plurality of frequency components of received radio signals to extract the transmit signal components.

2. A multicarrier transmission apparatus comprising:
at least two transmit antennas;
a signal generating section that adjusts a sequence of frequency arrangement and phases of transmit signal components in a time series and thus generates at least two transmit signals; and
a transmitting section that transmits the at least two transmit signals generated in the signal generating section from the transmit antennas, respectively.

3. The multicarrier transmission apparatus according to claim 2, wherein the transmitting section transforms each of the at least two transmit signals generated in the signal generating section into an orthogonal frequency division multiplexing signal to transmit from respective one of the transmit antennas.

4. A multicarrier reception apparatus comprising:
a single reception antenna; and
a transmit signal component acquiring section that combines a plurality of frequency components of received signals received at the reception antenna to extract transmit signal components.

5. The multicarrier reception apparatus according to claim 4, wherein the transmit signal component acquiring section performs orthogonal frequency division multiplexing demodulation on the received signals, and extracts the transmit signal components based on demodulated signals and channel estimation values estimated using the demodulated signals.

6. A multicarrier communication apparatus comprising:
the multicarrier transmission apparatus according to claim 2; and
the multicarrier reception apparatus according to claim 4.

7. A multicarrier communication apparatus comprising:
the multicarrier transmission apparatus according to claim 3; and
the multicarrier reception apparatus according to claim 5.
